(19) United States
(12) Patent Application Publication
(10) Pub. No.: US 2014/0304513 A1
(43) Pub. Date: Oct. 9, 2014

(54) STORAGE DRIVE PROCESSING MULTIPLE COMMANDS FROM MULTIPLE SERVERS

(71) Applicant: Nexenta Systems, Inc., Santa Clara, CA (US)

(72) Inventors: Robert E. NOVAK, Union City, CA (US); Caitlin BESTLER, Sunnyvale, CA (US)

(73) Assignee: Nexenta Systems, Inc.

(21) Appl. No.: 14/312,305

(22) Filed: Jun. 23, 2014

Related U.S. Application Data
(63) Continuation of application No. PCT/US2014/032408, filed on Mar. 31, 2014.
(60) Provisional application No. 61/807,216, filed on Apr. 1, 2013.
(60) Provisional application No. 61/865,506, filed on Aug. 13, 2013.
(60) Provisional application No. 61/865,716, filed on Aug. 14, 2013.

(51) Int. Cl. H04L 29/06

(52) U.S. Cl. CPC H04L 63/061
USPC 713/171

(57) ABSTRACT

One embodiment of the invention relates to a key/value storage device. The key/value storage device includes a storage medium for storing data, a network interface for receiving commands sent by multiple servers, and a controller. The controller processes a put command from a server to store a binary data object on the storage medium. The put command passes a key associated with the binary data object, and returns a unique digest of the binary data object to the server via the network interface. Another embodiment relates to a storage drive. The storage drive includes a network interface for receiving, and a controller for processing, multiple commands from multiple servers. Other embodiments, aspects and features are also disclosed.

### CROSS-REFERENCE TO RELATED APPLICATION(S)

The present patent application is a continuation of International Application No. PCT/US2014/032408, filed Mar. 31, 2014, the disclosure of which is hereby incorporated by reference in its entirety. PCT/US2014/032408 claims the benefit of U.S. Provisional Patent Application No. 61/865,716, filed Aug. 14, 2013, the disclosure of which is hereby incorporated by reference in its entirety. PCT/US2014/032408 also claims the benefit of U.S. Provisional Patent Application No. 61/865,506, filed Aug. 13, 2013, the disclosure of which is hereby incorporated by reference in its entirety. PCT/US2014/032408 also claims the benefit of and priority to U.S. Provisional Patent Application No. 61/807,216, filed Apr. 1, 2013, the disclosure of which is hereby incorporated by reference in its entirety.

### BACKGROUND

1. Technical Field

The present disclosure relates generally to data storage systems.

2. Description of the Background Art

It has been useful historically to have a hardware data storage device hold a great deal of data and do pre-computing of information about the storage of the data. For example, a hardware data storage device may hold not only the data, but a checksum that helps to ensure the retrieval of storage without errors. In addition, by organizing data into logical blocks, hardware data storage devices have attempted to minimize internal fragmentation and maximize the contiguous storage of the blocks. Minimizing internal fragmentation avoids large blocks containing only small amounts of data, while maximizing the contiguous storage of the blocks reduces the latency in retrieving the data.

### SUMMARY

One embodiment of the invention relates to a key/value storage device. The key/value storage device includes a storage medium for storing data, a network interface for receiving commands sent by multiple servers, and a controller. The controller processes a put command from a server to store a binary data object on the storage medium. The put command passes a key associated with the binary data object, and returns a unique digest of the binary data object to the server via the network interface.

Another embodiment relates to a storage drive. The storage drive includes a network interface for receiving, and a controller for processing, multiple commands from multiple servers.

Other embodiments, aspects, and features are also disclosed.

### BRIEF DESCRIPTION OF THE DRAWINGS

FIG. 1 depicts an exemplary implementation of the structure of a KEY data structure in accordance with an embodiment of the invention.

FIG. 2 depicts an exemplary organization of a key table in the key/value storage device in accordance with an embodiment of the invention.

FIG. 3 depicts an exemplary linked list of hash entries in accordance with an embodiment of the invention.

FIG. 4 depicts a storage system in accordance with an embodiment of the invention.

FIG. 5 depicts a simplified example of a computer apparatus which may be configured as a server in the system in accordance with an embodiment of the invention.

### DETAILED DESCRIPTION

Overview

From one point of view, the presently-disclosed pertains to a data storage device that avoids notions of physical media constraints and addresses, such as platter, track/cylinder, block, and offset. Instead, in accordance with an embodiment of the invention, the data storage device uses an innovative key/value storage model.

It is expected that key/value storage devices (key/value storage drives) may utilize non-volatile storage technologies, such as hard disk drive technology and solid-state drive technology. It is also contemplated that key/value storage devices may also utilize volatile storage technologies.

In an exemplary implementation, the key/value storage device disclosed herein stores binary large objects (BLOBs) of data. A BLOB may also be referred to herein as a binary data object. The payload data of a BLOB may be referred to herein as its VALUE. In an exemplary implementation, there are multiple layers of protocols that combine to perform layered actions. These layers of protocols may be referred to as data networking layers.

Every BLOB does not need to hold a large amount of binary data. However, in one aspect of the invention, the maximum allowed size of a BLOB is very large and need only be limited to the available capacity of the storage device. Under this data storage paradigm, this is not necessarily a significant constraint since a large BLOB may be split into smaller BLOBs by higher-level protocol layers that are scattered across multiple devices.

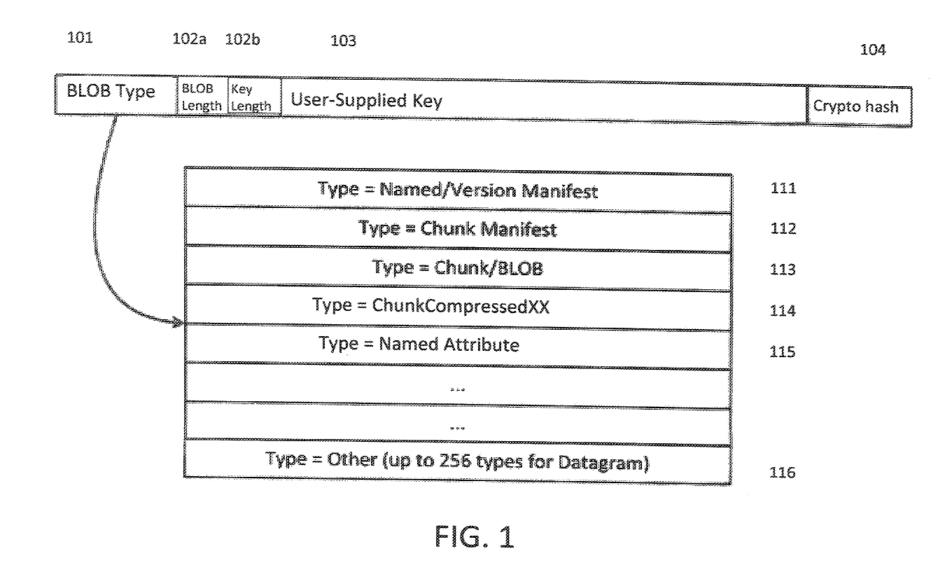

A User-Supplied (User-Defined) Key may be part of a KEY data structure that is passed to the key/value storage device to store or access a BLOB. In accordance with an embodiment of the invention, the User-Supplied Key may be used by the hardware data storage device to generate an internal location for the stored BLOB. An exemplary implementation of the structure of the KEY data structure, including the User-Supplied Key field, is described below in relation to FIG. 1.

In one aspect of the invention, the BLOB may be located internally, by either an “anonymous” name (anonymous key) for the BLOB or a name unique (User-Supplied Key) to the BLOB. In an exemplary implementation, the anonymous name is a cryptographic hash of the BLOB's contents that may be referred to as the “anonymous (content) key”, and the unique name may be an encoded user-supplied key that may be referred to herein as the “User-Supplied Key”. The anonymous (content) keys and the User-Supplied Keys may be stored within the key/value storage device and used for internal location of the BLOBs stored therein. In an exemplary implementation, the BLOB associated with a “User Supplied Key” may be the “anonymous (content) key” of the User Supplied BLOB.

The key/value storage device disclosed herein may be a client to one or more storage servers and may be accessed by the storage servers via a network interface. A storage system built using key/value storage devices is scalable such that tens, hundreds, thousands, tens of thousands, and so on, servers may access a multitude of key/value storage devices in the storage system.

Two technology layers may be used in the method to access a key/value storage device. The first layer provides an Application Programming Interface (API) for the key/value storage device. The second layer involves a data networking protocol layer to access the key/value storage device by way of a network interface.

The API layer provides for the issuance of commands to the storage device. The commands may include commands to store data, retrieve data and delete data. An exemplary set of commands for an API of a key/value storage device is described below under the Exemplary Commands section.

The data networking layer allows the API commands to be sent to the storage device that is a client to multiple servers. The network interface of the key/value storage device may be Ethernet, PCIe, SAS, or other bus or data network technologies. For example, the network interface may use a dedicated point-to-point bus, or the network interface may use UDP Ethernet.

In an exemplary implementation, the data networking layer may utilize an unreliable datagram packet or Jumbogram, under the user datagram protocol (UDP), Infiniband™, or other such protocols, to communicate commands to the key/value storage device. Alternatively, commands may be communicated by way of a connection-oriented protocol, such as transmission control protocol/internet protocol (TCP/IP), or other such protocols.

A) KEY Data Structure

FIG. 1 depicts an exemplary implementation of a KEY data structure which may be passed to the key/value storage device in accordance with an embodiment of the invention. As shown in FIG. 1, the KEY data structure may include the following fields:

A1) the encoded BLOB type 101, which may be of arbitrary length in some implementations;

A2) the encoded BLOB and key lengths 102a and 102b;

A3) the encoded User-Supplied Key 103 (also referred to as the encoded User-Defined Key or simply the encoded User Key) which may be of arbitrary length and may be, but does not have to be, the cryptographic hash of the BLOB, i.e. may be the anonymous (content) key; and

A4) the encoded unique digest is preferably one that does not require referencing a central authority. For example, the unique digest may be a cryptographic hash (Crypto hash 104) of the BLOB with the encoded User-Supplied Key. A unique digest number that requires referencing a central authority may also be used. However, because such a number has to be obtained from and referenced by a central authority, it does not permit distributed applications to scale.

Note that, since cryptographic hash algorithms such as SHA256 and SHA512 are serial in the nature, it is possible for the receiver (e.g., the receiving device) to compute the cryptographic hash of the BLOB and then continue computing the cryptographic hash of the User-Supplied Key appended to the end of the BLOB. In this way, the receiver is able to verify that both the BLOB and the User-Supplied Key have been received intact without corruption. Doing so is at a very small incremental cost above the cost of verifying the BLOB alone.

In one implementation, the encoding of the fields in the KEY data structure may be a form of JSON (JavaScript Object Notation) encoding and that the encoding method may indicate this encoding method with an ASCII string by the name of “JSON”. Other implementations of the encoding are possible. In one implementation, a GetEncodingMethods command may be used to retrieve the list of such encodings and/or fetch a copy of the documentation and/or pseudo-source or portable source (e.g., JavaScript) code to perform such encodings.

While this section details an exemplary implementation of a key structure, there are many different structures possible, and the exact structure is not critically important. What is important is that the receiving process/device will guarantee the integrity of both the BLOB and the key that it uses to find the BLOB.

There are a multitude of methods by which this can be achieved. In all cases, both the key length and the BLOB length are known or specified to ensure correct receipt of each. The encoding of the key, including the key length, may be all part of the key and is embedded in the key sent to the receiving process/device in an opaque fashion (i.e. the internal structure of the overloaded key may be invisible to the receiving process/device).

One of the protections for the key may be to provide a separate checksum/digest of the key that is embedded in the key, but that would require that the receiving process/device understand the internal structure of the key. On the other hand, if the receiving process/device is computing a cryptographic hash digest of the BLOB, it could extract that digest/hash of the BLOB after it has completed the length of the BLOB, and then add the key to the tail end of the BLOB and continue computing a cryptographic hash/digest of the BLOB plus key as a second result. If both digests are pre-computed by the sender and provided in the PUT command, then the receiving device can verify correct receipt of both the BLOB and the key. Alternatively, the receiver/device can return both digests to the sender and it becomes the sender's responsibility to verify that the key and BLOB were received correctly.

A1) BLOB Type

There may be multiple types of BLOBs as specified in the BLOB Type field 101 of the exemplary KEY data structure. All of the BLOB types described below are an exemplary set of BLOB types. Appropriate sets of BLOB types may be used to implement a wide variety of storage systems.

In an exemplary implementation, the multiple BLOB types may include at least a minimum set of types that are required by the Cloud-Copy-On-Write (CCOW™) storage technology that is available from Nexenta Systems of Santa Clara, Calif.. The Nexenta CCOW™ storage technology is an object storage system that stores object payloads in chunks.

An exemplary set of types of such an object storage system may include the following: a named or version Manifest type (Type=Named/Version Manifest) 111; a Chunk Manifest type (Type=Chunk Manifest) 112; a Chunk or BLOB type (Type=Chunk/BLOB) 113; a compressed Chunk type (Type=ChunkCompressedXX) 114; and a named attribute type (Type=NamedAttribute) 115. Other types 116 may also be defined. In one implementation, there may be up to 256 defined types. For example, a Type=Chunk BackReference may be defined.

Type=Named/Version Manifest (TypeNamedManifest/TypeVersionManifest)

The TypeNamedManifest and TypeVersionManifest are synonyms for the same type. This type of BLOB is a BLOB that will have an object name key in addition to an anonymous (content) key. In an exemplary implementation, this type of BLOB may include a name of the object in plaintext (perhaps, Unicode-8/16) as well as the cryptographic hash of the name, static attribute data (creation date/time/source), the list of hashes for the Chunks, and, possibly, Chunk Manifests for Chunks that constitute the object.

Type=Chunk Manifest (TypeChunkManifest)

In an exemplary implementation, this type of BLOB is a BLOB that contains a list of chunk references, where each chunk reference specifies an offset for the chunk being referenced, its logical length and the cryptographic hash of the Chunk payload. Chunk References may be to chunks, or to other Chunk Manifests. In some implementations, there may be a third type of Chunk Manifest which includes the payload inline within the chunk reference itself. In one implementation, there is no fixed limit on the depth of the Chunk Manifest tree.

Type=Chunk or BLOB (TypeChunk/TypeBLOB)

In an exemplary implementation, this type of BLOB is a BLOB that points to a Chunk of user-defined bytes of data (i.e. a BLOB of pure user-defined data). In other words, this type of BLOB contains a Chunk of user-submitted payload data.

Type=Compressed Chunk (TypeChunkCompressedXX)

This is a BLOB that has been compressed with compression method XX, where XX is to be replaced by a name or code identifying the compression method.

Type=Named Attribute (TypeNamedAttribute)

This is a BLOB that contains attribute data about an object. The key for this type of BLOB may be the cryptographic hash of the name of an object, but with this type identifier, rather than TypeNamedManifest

BLOBs of this type may contain information on owners, authorized users, Access Control Lists, permitted actions, last access time, etc. These pieces of volatile or dynamic attributes of the object may be stored internally as key value pairs within the BLOB.

Note that each time that any of these attributes are updated, there may be a transaction log created at the bucket or tenant level. The transaction log may record a timestamp of when the attribute is updated, the ServerID of the server that initiated the action, and the identification of the user/process that performed the action. Some of these transaction log entries may be created by the device as an implicit part of a PUT/GET/DEL operation. Other transaction log entries may only be added when they are explicitly designated through additional parameters to the above commands. (See Device Logging below.)

A2) BLOB and Key Lengths

In the exemplary KEY data structure, this field provides the length of the BLOB in bytes and also the length of the User-Supplied Key. In one implementation, this field may provide the byte offset of the last entry in the BLOB and may not necessarily represent the on-disk storage size.

A3) User-Supplied Key

This field provides the User-Supplied Key in the exemplary KEY data structure. In one embodiment, the User-Supplied Key may be any arbitrary value. In an exemplary implementation, the user-supplied key may be a cryptographic hash of the BLOB, i.e. the anonymous (content) key. Note that, in some implementations, an additional field indicating the length of the User-Supplied Key may be utilized in the KEY data structure.

A4) BLOBkey Digest

In the exemplary KEY data structure , this field provides a unique digest (which may be a cryptographic hash, checksum or other digest) of the BLOB plus the User-Supplied Key appended to the end of the BLOB. A mechanism may be used to ensure that the device will not store a BLOB or use the User-Supplied Key unless the computation of the BLOBkey digest by the receiver is successful (i.e. matches the one provided in this field).

Note that, in an exemplary implementation, there is no guarantee that the User-Supplied Key itself provides a functional check of the BLOB contents because the User-Supplied Key may be arbitrarily defined, instead of being a cryptographic hash of the contents.

In a preferred implementation, some the commands that follow (e.g., put commands) will return the cryptographic hash of the BLOB. In this way, the method disclosed herein provides a round-trip verification of the BLOB content being received correctly. This round-trip verification allows the sender to verify that the BLOB was received intact.

B) Device Logging

In order to keep the operations of separate servers/masters of the device/process that is managing the non-volatile storage atomic in their nature (i.e. single uninterrupted operations that are isolated from all other operations), it is highly desirable that the device log special transactions. It is possible that the device functionality is preserved without such a transaction log, but at a very high performance penalty.

In a preferred embodiment, this transaction log may be kept in a non-volatile cache memory. In an exemplary implementation, the transaction log is stored in a form of high-speed RAM memory, and the key/value device has sufficient electrical charge to preserve the volatile contents of that memory into a non-volatile store (e.g. flash memory) in the event of an unexpected power failure.

In the sections that follow, there are specific commands that can have additional parameters that specify information that is to be added to the transaction log in the same atomic step that the command action is taken.

The key/value storage device may manage the content of the log in such a way that the volatile transaction log cache will periodically be preserved on the device/process long-term non-volatile storage.

In one embodiment, the key/value storage device may have no knowledge of the file system that is being managed on the device itself, but it will faithfully perform the logging operations upon explicit request for certain operations (with the transaction log contents specified by the source server). Other operations (e.g.

Compare and Exchange operations) may be logged by the device in the cache and on the device without further directives from the source server.

C) Exemplary Commands

The following is a set of commands that may be available on a key/value storage device in an exemplary implementation. Of course, additional or different commands may be provided in other implementations.

C1) Put(KEY, Value);

C1a) PutChunk(Value);

C1b) PutNamedManifest(KEY, Value);

C1c) PutChunkManifest(KEY, Value);

C1d) PutCompressedChunk(KEY, TypeCompressionXX, Value);

C2) PutAuthenticationMethod(Method_Name, . . . );

C3) PutAuthenticate([server,] Method);

C4) PutContentHashMethod([server,] Method, . . . );

C5) PutSerialUpdate(CXserial_Type, KEY, OldCXkey, Value);

C6) PutNamedManifestDevice(KEY, Value, DeviceID);

C6a) PutNamedManifestDeviceLOG(KEY, Value, DeviceID, VersionBLOB);

C7) PutChunkDevice(KEY, Value, DeviceID);

C8) Get(KEY);

C8a) GetSerialKey(CXSerial Type, KEY);

C8b) GetSerialKeyValue(CXSerial_Type, KEY);

C9) GetKeyDevice(Key, DeviceID);

C10) GetN_Keys(Index, N);

C11) GetFreeKeySpace( )

C12) GetFreeBLOBSpace( )

C13) GetAuthenticationMethods( )

C14) GetHashMethods( )

C15) GetChecksumMethods( )

C16) Del(KEY);

C17) Detach(Server);

C18) AbortPut; and

C19) AbortGet.

In an exemplary implementation, each of the above commands may be available as logging versions of the command, where the source of the command may direct the contents placed in the device specific transaction log. In addition, there may be specific commands that are used to mark the time in the transaction log, or there may be specific commands to synchronize the clock on the device so that the device may maintain its own timestamps on log entries or periodically insert timestamps into the transaction log stream.

C1) Put(KEY, Value)

In an exemplary implementation, this is the basic “put” command. When the user submits a “put” of a Value (BLOB) that is referenced by a KEY data structure, the command will return the cryptographic hash of the Value. If there is an error, the key/value storage device may return an error indication and an optional time value.

Returning the cryptographic hash of the Value (BLOB) demonstrates that the BLOB was received intact by the receiver. The actual KEY data structure that is sent by the command is an overloaded value which contains additional information. The additional information may include a key digest which may be verified by the receiver.

Multiple failure codes for this command are possible. Most of the failure codes may be distinct values that are encoded in the returned value. The remaining failure codes may be an indication that the device is busy for a period of time. The period of time may be expressed in microseconds in preferred implementations at the present, and the busy indication may indicate that the server should retry the request later. In the future, as devices can process transactions more quickly, the time interval may be expressed in multiples of smaller units of time such as nanoseconds (1.0×10⁻⁹ seconds) or picoseconds (1.0×10⁻¹² seconds).

The reasons for the delay (i.e. the temporarily busy indication) may be various and dependent on the internal implementation at the receiver. For example, the delay may be due to the fact that the transaction queue for the device is currently full and that additional data would exceed the capacity of the non-volatile queue. After a time interval, the device will have flushed a sufficient number of entries from the transactional queue to accept additional transactions to “put” data. Another possibility is that the device is temporarily full (while it is performing internal reorganization) and after a period of time will have space available.

This command places a BLOB Value into storage for later retrieval. In one embodiment, there are two different keys that may be used for accessing the BLOB:

1. the anonymous (content) key (i.e., the cryptographic hash of the content); and

### 2. the User-Supplied Key.

The first key (the anonymous key) of the BLOB is the cryptographic hash of the Value that constitutes the BLOB. The sender and the receiver must agree on the cryptographic hash algorithm that is used. In many implementations, this may be constrained by the receiver's available list of cryptographic hash algorithms. In other implementations, the sender may have previously provided to the receiver a function or functions which it can use to compute cryptographic hashes.

The second key is User-Supplied (User-Defined) Key for the BLOB which is a parameter (within the KEY data structure) to this put command. The User-Supplied Key may be any arbitrary encoded set of bits.

An exemplary implementation of the User-Supplied Key may use JSON encoding. The limits on the size of the allowed User-Supplied Key may be device specific. An exemplary implementation may have a minimum key size of 512 bits. An alternate implementation may have a minimum key size of 1024 bits to allow for future growth in key size for robustness.

In an exemplary implementation, where the key/value storage device is used as part of an object storage system, the User-Supplied Key may be the cryptographic hash of the string

“/<cluster_name>/<tenant_name>/<bucket_name>/<object_name>”. The cluster_name may refer to the name of the cluster of servers that provide services for multiple tenants. Other interpretations or mappings are also possible. The tenant_name may refer to the name of a tenant of a multiple service provider (MSP) that is purchasing services for storage. Other interpretations are possible. The bucket_name may be mapped to a department or a project within the tenant organization. Other interpretations or mappings are possible. The object_name may be mapped to a name of an object that is associated with the content of the BLOB.

In accordance with an embodiment of the invention, if the receiver (i.e. the device receiving the Put command) finds that it has already stored the BLOB (e.g., when it discovers a duplicate anonymous key), the receiver does not need to store a new copy of the BLOB. However, as an integrity check or audit to verify that the cryptographic hash algorithm is sufficiently strong, the host server may want to “get” the BLOB that the device has already stored and verify that the contents is the same as the “value” that the server is attempting to “put.” This may be done on a sampling basis, for example, once in every N times that there is a duplicate anonymous key.

In an exemplary implementation, the Put command may return a datagram with the following fields: a success or failure flag; if successful, the cryptographic hash of the BLOB/Value; and if unsuccessful, an error code which may be encoded with the rest of the returned datagram. In the exemplary implementation, the error code may include the time or time interval at which a retry may succeed.

In an exemplary implementation, the API layer may include multiple “subcommands” that are above (i.e. that utilize) the basic Put command described above. Exemplary subcommands for Put are detailed in the following subsections.

C1a) PutChunk (Value)

In an exemplary implementation, the PutChunk command is in an API layer above the basic Put command (i.e. the PutChunk command may call the basic Put command). This command may encode the KEY data structure for the Value (BLOB) according to the above description of the KEY data structure. The generation of the KEY data structure is in accordance with the above description of that structure.

Note that the net effect of the operations is to create a “plain Chunk” which encodes a key to contain a number of sub-fields (an overloaded key). If the BLOB/key type is the default type supported by the device, then the key is optionally NOT encoded. Otherwise, if the server/device uses anything other than the default type, that is noted by changing the ChunkBlobType to encode for a Chunk that uses a different cryptographic hash than the device default. The type of encoding is one that must be supported by the device. This may necessitate a command to fetch a list of encodings for such hash functions and a command to select which one is the default that is used for the device. Candidates may include SHA512, SHA256, SHA2 and SHA3 among others.

C1b) PutNamedManifest(KEY, Value)

In an exemplary implementation, the PutNamedManifest command is in an API layer above the basic Put command (i.e. the PutNamedManifest command may call the basic Put command). This command may encode the KEY data structure for the Value (BLOB) according to the above description of the KEY data structure.

The Value here is the Manifest for an object. The structure of the key for this special object will affiliate the cryptographic hash of the name of the object as the key element. The receiver will make two entries in the key table, one using the User-Supplied Key and the other will be the cryptographic hash of the BLOB value or content.

C1c) PutChunkManifest(KEY, Value)

In an exemplary implementation, the PutChunkManifest command is in an API layer above the basic Put command (i.e. the PutChunkManifest command may call the basic Put command). This command may encode the KEY data structure for the Value (BLOB) according to the above description of the KEY data structure. A preferred implementation of this command provides the cryptographic hash of the BLOB value as the User-Supplied Key value.

C1d) PutCompressedChunk(KEY, TypeCompressionXX, Value)

In an exemplary implementation, the PutCompressedChunk command is in an API layer above the basic Put command (i.e. the PutCompressedChunk command may call the basic Put command). This command may encode the KEY data structure for the Value (BLOB) according to the above description of the KEY data structure.

The special aspect of this command is that the Type field in the Key will encode the information about the compression algorithm used by the object. It is the sender's responsibility to perform the compression of the Value. Note that this can be a synonym for noting that the Value has been encrypted using algorithm XX.

C2) PutAuthenticationMethod(Method_Name, . . . )

The PutAuthenticationMethod command is a privileged command. This command will initialize the device with the information to interact with a supported authentication method/server. The method must be a method that is available on the device and can be found in the list of methods returned by the GetAuthenticationMethods( )command. In addition to naming the method, additional parameters to this command are method dependent and will be documented with the method list supported by the device. Preferably, all necessary documentation is stored in the firmware/flash media on the storage device and may be retrieved with the key formed by the cryptographic hash of a pre-defined string (such as, “Authentication Method:Method:Documentation” for the documentation on the use of the Authentication Method, for example). Some sample types of authentication methods might include: LDAP; Radius; Kerberos; etc.

C3) PutAuthenticate ([server,] Method)

In an exemplary implementation, the PutAuthenticate command adds a “server” to the list of servers that are allowed to access information on the key/value storage device. The authentication is not for end users of the servers that interact with the device, but the authentication is for the “server” to allow it to issue commands to the device. Finer grained authentication (e.g., of individual users on the servers), may be handled by the servers themselves. The “server” identifier may be implicit in the datagram/jumbogram that is passed to the device. In an exemplary implementation, a transaction log entry may be provided as an implicit part of this command that records the timestamp, server and authentication method. The transaction log entry may include opaque data that allows a higher storage protocol layer to complete a transaction on a restart after a failure before the original transaction was fully written.

Note that, in a preferred embodiment, the log entry is written first and the atomic transaction completed later, to allow for the aforementioned recovery case. However, this ordering is not necessary; writing of the log entry does not have to occur before performance of the transaction. In another embodiment, performance of the transaction may begin prior to the log entry being written. In either case, once the log entry is written, regardless of the state of the atomic transaction, the command may be acknowledged by the device/receiver while the atomic transaction completes.

C4) PutContentHashMethod([server,] Method, . . . )

In an exemplary implementation, the PutContentHashMethod sets the cryptographic hash method that is used by default for all Values passed from the “server” to the device until the server is no longer authenticated to the device. The “server” identifier may be implicit in the datagram/jumbogram that is passed to the device.

C5) PutSerialUpdate(CXserial_Type, KEY, OldCXkey, Value)

In an exemplary implementation, there are two possible serial updates or Compare and Exchange serial types (CXserial_Types): Update VersionList for a Named Object; and Update BackReference List for a Chunk. Other implementations with similar operations are possible.

Note that a compare and exchange operation is an atomic operation, that may be implemented as an instruction. A compare and exchange operation compares the contents of a location with a given “old” value. If and only if the two values are the same, the operation replaces the contents of a location with a new value. By performing this operation in an atomic step, multiple threads/tasks/computers are allowed to synchronize their operations without interference or using locks and mutual exclusion techniques. The returned value is the value in the location at the end of the operation. If the operation succeeds, the value at the location is the new given value. If the operation failed, the value at the location will remain the value found at the location that did not match the given “old” value. Failure of the compare and exchange operation indicates that another asynchronous process modified the location between the time the requesting process “read” the location value and requested a compare and exchange update of the value.

The PutSerialUpdate function will return the value of the compare and exchange key that it found at the end of the command. If the key value returned is the input Key value, then the command was successful. All other return values are an indication of an error.

When multiple servers are accessing a single device, preferred implementations of the Serial Update Process will serialize the acknowledgement of requests for serial update and may bias the serialization process to give higher priority (by postponing some updates) to servers that were most recently “failed” in their update. Although this is not a mandatory optimization, in environments where there are disparities in the CPU processing power of the servers, and/or the connection speed of a server to the device, this optimization can prevent update starvation, where a server's update may get deferred for an extraordinarily long time due to the connectivity and/or processing advantages of other servers.

So to make the unique trees or linked lists, the key/value storage device may copy the tree from the old version, delete the sourceID/Timestamp that appears in the old copies and substitute in the sourceID/Timestamp of the new backreference or version. Preferred implementations may use the sourceID/Timestamp since that would make diagnostic decoding of the content stored by the receiver easier to identify when trying to untangle a disk drive that got caught in an intermediate state by a power failure.

An ill-timed power failure could lead to both the old tree (linked list) that is still rooted by the compare and exchange old value and the new tree (unrooted—but supposed to be attached to the new value), to be held in the receiver's storage at the same time just before the completion of the Serial update Compare and Exchange. The above mechanism allows a diagnostic application to untangle the state of the storage. Note that, in the event that a Serial Update fails, the disposal of the “failed” tree may be placed on a lazy delete queue. When the update fails, the failed tree is placed on the lazy delete queue and fetches the new tree that succeeded since the pointer to that tree returned as the failure code. We then build another new tree (replacing the sourceID/Timestamp as an extra field in each block/entry) and resubmit.

In accordance with an embodiment of the invention, to create unique trees, the key/value storage device makes sure there are unique elements in each of the back reference blocks or version blocks that are being rewritten. One way to do that is by putting the source ID and timestamp into each one of those blocks as part of the value that is encoded in the BLOB to create the cryptographic hash because then there will be no collisions with the prior version.

CXserial_Type: Update VersionList for a Named Object

This type of serial update performs an update of the version list associated with a named object with the new version list. This requires that the update be from a known prior value to a new value; that is the reason for the CXkey (Compare and Exchange key). Prior to updating the base or root of the version list (containing the most recent version), the server must make a complete copy of the version list.

In each of the Chunks that are members of the linked list (assembled in monotonically increasing order and sorted by date and source serverID), the server performing an update must “sign” the additional Chunks with the timestamp and serverID of the most recent update. The purpose of this signature is to ensure that the cryptographic hash value of the Chunk containing the list of prior versions will be distinctively different. This is so that the older list and newer list can be deleted independently of each other without resorting to reference counts in the event that the version lists might have identical content for some sets or chunks of previous versions.

CXserial_Type: Update BackReference List for a Chunk

This serial update performs an update of the list of back references associated with a Chunk. This requires that the update be from a known prior value to a new value; that is the reason for the CXkey. Prior to updating the base or root of the back reference list (containing the most recent version back reference), the server must make a complete copy of the back reference list.

In each of the Chunks that are members of the linked list (assembled in monotonically increasing order and sorted by date and source serverID), the server performing an update must “sign” the additional Chunks with the timestamp and serverID of the most recent update. The purpose of this signature is to ensure that the cryptographic hash value of the Chunk containing the list of prior back references will be distinctively different. This is so that the older list and newer list can be deleted independently of each other without resorting to reference counts in the event that the version lists might have identical content for some set of previous versions.

Referring back to the Putserialupdate command, the Key may be either a Named Object Key or the cryptographic hash of a Chunk. In order to support a Version List, the Key must point to a Named Object. This is enforced on the receiver which is a side-effect of the serialization process.

The OldCXkey is the Compare and Exchange Key that the GetSerialKey command retrieves from the device. In order to update the CXSerial_Type BLOB, the device must find that the OldCXkey is the one in current use. If OldCXkey is the one in current use, then the device deletes the OldCXkey object and replaces it with Value, computes a cryptographic hash of the Value, and returns that value. If OldCXkey is not the one in current use, then the device returns the CXkey of the Value that it finds (that was most likely updated by a different server).

C6) PutNamedManifestDevice(KEY, Value, DeviceID)

In an exemplary implementation, the PutNamedManifestDevice command is a special form of the Put command that bypasses the hashing function for selection of a drive and forces a put to a specific drive.

C6a) PutNamedManifestDeviceLOG(KEY, Value, DeviceID, VersionBLOB)

In an exemplary implementation, the PutNamedManifestDeviceLOG command is a special form of the PutNamedManifestDevice command that directs the device to append a specific log entry to the device internal transaction log.

C7) PutChunkDevice(KEY, Value, DeviceID)

In an exemplary implementation, the PutChunkDevice command a special form of the Put Chunk command that forces the Chunk to be placed on a specific Device.

C8) Get(Key)

In an exemplary implementation, the Get command returns a Value (BLOB) that is found by looking up the Key in its internal tables. In the instances where the user key is NOT the cryptographic hash of the BLOB (after stripping off the Type and other ancillary fields used in forming the keys), then the receiver will retrieve the cryptographic hash of the BLOB from the receiver's internal key list and use that to retrieve the BLOB.

The space for user-defined keys and cryptographic hash digest keys may be stored in the same key space if the user chooses defined keys that have a different size than the cryptographic hash algorithm. If the user keys are the same size as the cryptographic hash digest keys, then they will have to be maintained as two separate lists on the same device which could lead to higher implementation expense. In an exemplary implementation, the most frequent use of a key value for a Named or Version Manifest is the cryptographic hash digest of the name itself which for known cryptographic hash algorithms will be distinct from the cryptographic hash of Chunks or objects.

C8a) GetSerialKey(CXSerial_Type, Key)

In an exemplary implementation, the GetSerialKey command is used to retrieve a key which can be updated by the compare and exchange method.

C8b) GetSerialKeyValue(CXSerial_Type, Key)

In an exemplary implementation, the GetSerialKeyValue command will return the compare and exchange key and the BLOB affiliated with that key. This forces the BLOB retrieval to be done in an atomic operation independent of other commands that may be issued to the device by other servers.

C9) GetKeyDevice(Key, DeviceID)

In an exemplary implementation, the GetKeyDevice command is a special form of the Get command that forces that the BLOB is retrieved from a specific device.

C10) GetN_Keys(Index, N)

In an exemplary implementation, the GetN_Keys command returns a simple list of the encoded keys (named and anonymous) that are found in the internal key tables. The sender and receiver may have restrictions on the buffer space available when retrieving keys. This allows the keys to be retrieved in small groups. The keys may be encoded by a plurality of methods.

C11) GetFreeKeySpace( )

In an exemplary implementation, the GetFreeKeySpace command returns two integer values (64 bits is the minimum size but will be receiver specific) of the number of entries in the device's key table and the number of entries available. In preferred implementations, this data may also be available as an object that may be retrieved by an ordinary Get command.

C12) GetFreeBLOBSpace( )

In an exemplary implementation, the GetFreeBLOBSpace command returns an integer value (128 bits is the preferred implementation size but will be receiver specific) of the amount of free data space on the device. For various reasons (including internal reorganization by the device), this is only a snapshot value and two instances of this command with no other commands intervening, may yield two different values. In accordance with an embodiment of the invention, the device may perform internal reorganization of data on the device at any time.

C13) GetAuthenticationMethods( )→{“Method1”, “Method2”, “MethodN”}

In an exemplary implementation, the GetAuthenticationMethods command gets a list of the Authentication Methods that are supported by the device. From these names it is possible to form the string

“AuthenticationMethod:Method:Documentation” to retrieve documentation on the use of the AuthenticationMethod from the receiver/device in an exemplary implementation.

C14) GetHashMethods( )→{“Method1”, “Method2”, “MethodN”}

In an exemplary implementation, the GetHashMethods command gets a list of the methods that the device can use to verify a BLOB content with a cryptographic (or other) Hash. From the list of names it is possible to form the string “HashMethod:Method:Documentation” to retrieve documentation on the use of the HashMethod.

C15) GetChecksumMethods( )→{“Method1”, “Method2”, “MethodN”}

In an exemplary implementation, the GetChecksumMethods command gets a list of the methods that can verify the contents of the KEY field as passed to the device. The device may verify the KEY value with one of these methods and return the checksum as a verification that the KEY was received correctly. Note, under the Put command, that the device returns both a KEY checksum and a BLOB cryptographic hash to verify that the device has correctly receive the transmitted data.

Note that other Get commands are contemplated. For example, a GetHostList( )command may be used to return a list of hosts {Host1, Host2, . . . , HostN}.

C16) Del(Key)

In an exemplary implementation, the Del command is used by a server to delete a Key. When performing the Del operation, the server talking to the device is responsible for deleting properly:

1. Delete all keys that may point to an anonymous key that will be deleted (and vice-versa); and
2. Coordinate with other servers that may be managing the device.

C17) Detach(Server)

In an exemplary implementation, the Detach command may be initiated by the named Server. The Detach command may be a default internal command when a timeout interval has been exceeded with no communication with a named Server. The Detach command may also be initiated by other servers, but this would require appropriate privileges or permission.

C16) AbortPut

In an exemplary implementation, the AbortPut command will abort a Put operation that was previously initiated, but can be abandoned because other devices may have won the negotiation for put and this device did not. This operation may happen during a shutdown process as well.

C19) AbortGet

In an exemplary implementation, the AbortGet command will abort a command to fetch a BLOB that had been previously requested. This command may occur because there were other Get requests on other machines that may have a “better” answer (e.g. a more recent version of an object/Chunk). This is especially important for devices that take relatively long periods of time for mechanical operations to abort those operations and allow subsequent operations to occur in a shorter period of time.

D) Other Notes

Note that there are device specific pieces of information that are normally accessed from the device through specialized or dedicated commands. For these devices in a preferred implementation, those same values can be obtained by using the device specific form of the Get and Put commands (in this case, PutManifestDeviceID, PutChunkDeviceID and GetDeviceID). In this fashion, these privileged commands can be invoked directly from user code without having to address kernel mode I/O operations. Some examples of the specific pieces of information:

1. Capacity of device in bytes;
2. Capacity of device remaining in bytes;
3. Largest BLOB device can put; and
4. Average Latency to retrieve a BLOB.

E) Serialized Updating of Multi-Chunk Lists

In the above discussion of the PutSerialUpdate command, the method of updating a back reference or a version list that is larger than a single BLOB or Chunk is briefly discussed. In this section, a more detailed explanation is provided.

The PutSerialUpdate verb or command to the device tells the device to only replace an OldCXkey (Old Compare and Exchange key) with a new key (derived from the cryptographic hash of the Value) if the Old key exists on the device. This will require that the device actually implements multiple actions and has some understanding of the data structures that are involved. Consider the case where a Chunk stored on the device has multiple back references (it is a deduplicated Chunk that appears within many objects).

There is an implied model of the device behavior that underlies the following description. In the first place, each type of BLOB that is stored on the device with a Name of an object is stored by taking the cryptographic hash of the Name (typically “<Tenant Name>/<Bucket Name>/<Object Name>”). This cryptographic hash is stored in a hash table that the device maintains. Coinciding with this hash table entry is a copy of the cryptographic hash of the content that this named BLOB/Value type points to.

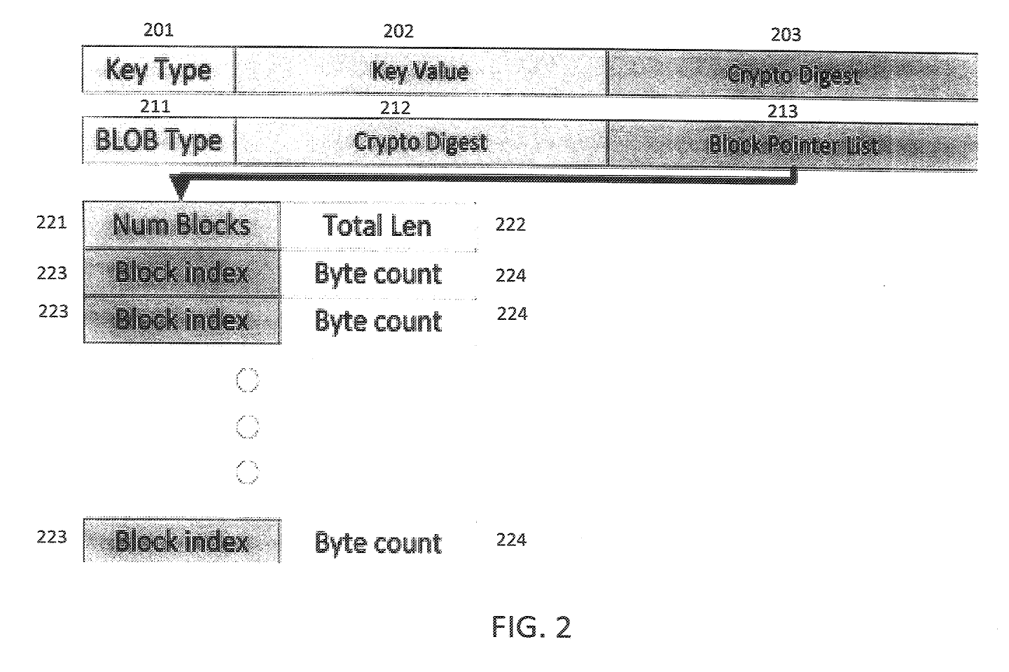

FIG. 2 illustrates a sample of how the key table may be organized on the key/value storage device in accordance with an embodiment of the invention. A list of key types 201 with a key value 202 (e.g. crypto hash of name), followed by either the crypto hash digest 203 of a BLOB, or a BLOB Type 211, with a crypto hash digest 212 followed by a pointer 213 to a list of blocks. The list of blocks may include fields for the number of blocks 221 and the total length in bytes 222. Each entry in the list may include a block index 231 and a byte count for the block.

F) Linked List of Keys

Although the API supports variable-sized keys, the key/value storage device may use a hash of the provided (and computed) keys to create a fixed-size table for implementation efficiency. That table will access linked lists of keys that are maintained in the device storage as device specific objects that may be additionally cached in high speed storage (e.g. RAM) on the device to speed access to the keys.

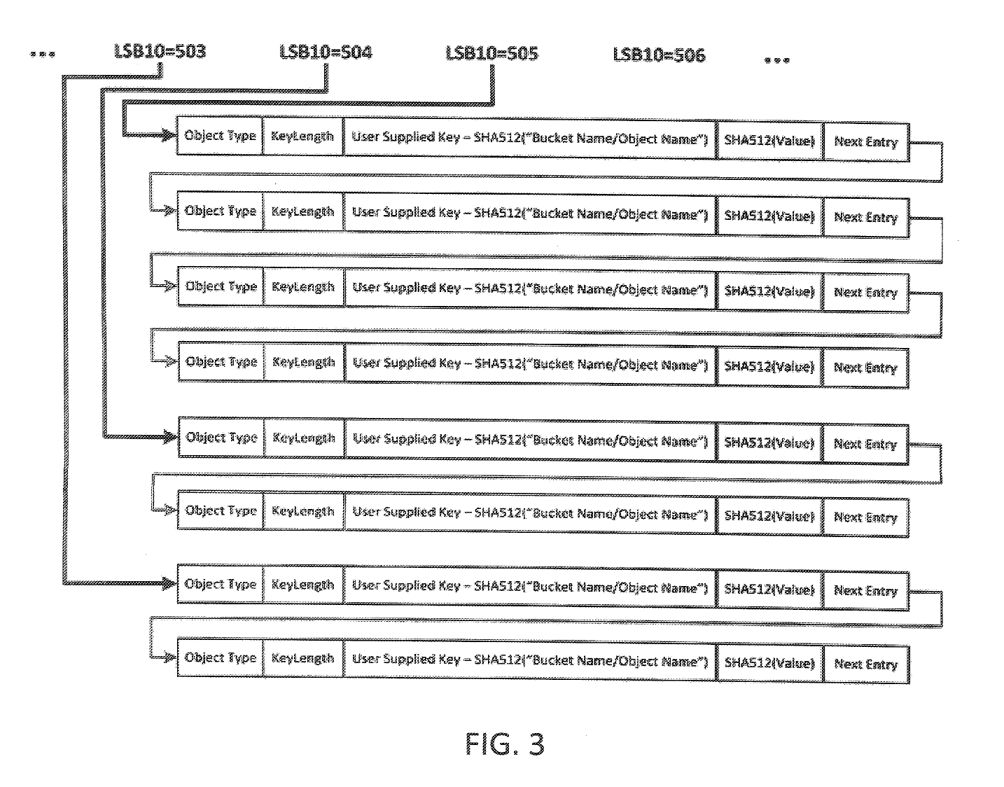

FIG. 3 depicts an exemplary linked list of keys in accordance with an embodiment of the invention. In the exemplary linked list, a predetermined number of (for example, ten) common least significant bits (LSB10 in FIG. 3) of the cryptographic hash (in this example, SHA512) of the object (or bucket) name is used to index into the linked list. When a user provides a “name key” (User-Supplied Key in FIG. 3) which is the cryptographic hash of the object/bucket name, that name key is used to index into the linked list and find the corresponding key entry. The key entry contains a copy of the anonymous key which is the cryptographic hash (in this example, SHA512) of the Value/BLOB associated with the key. The key entry also contains a pointer (Next Entry in FIG. 3) to the next key entry, if any, with the same common least significant bits.

G) System and Device Implementation

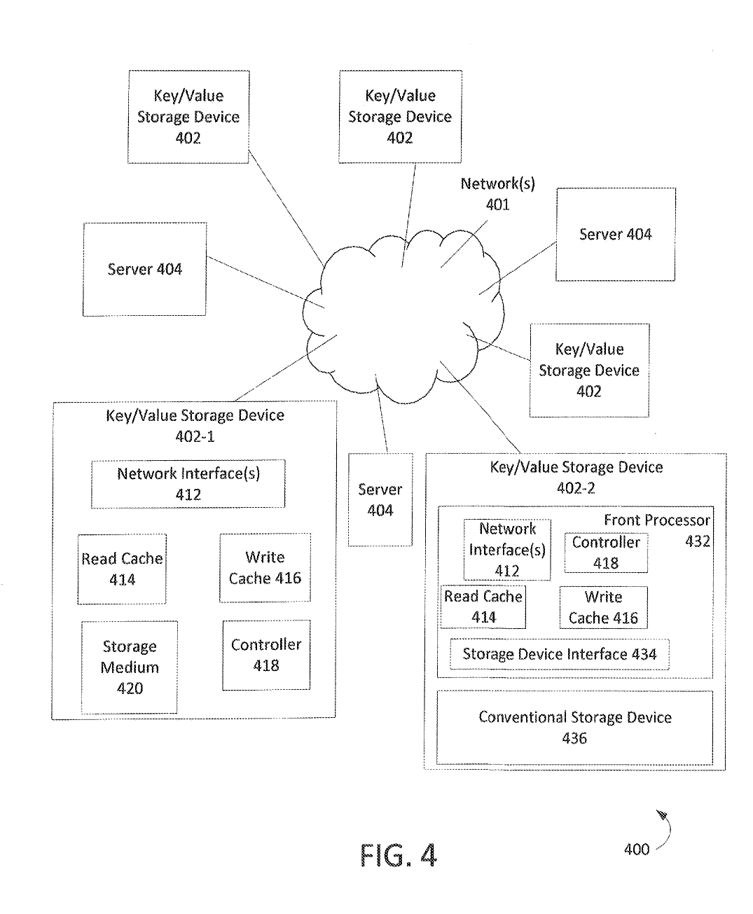

FIG. 4 depicts a storage system 400 in accordance with an embodiment of the invention. As shown, the storage system 400 includes a plurality of key/value storage devices 402 and a plurality of servers 404 interconnected by one or more communications networks 401. Also depicted in the figure are exemplary implementations of a key/value storage device 402.

In a first exemplary implementation, the operational components of the key/value storage device 402-1 include one or more network interfaces 412, a read cache 414, a write cache 416, a controller 418, and a storage medium 420. As discussed above, the network interface(s) 412 is (are) used such that the device 402 may be accessed by a multitude of servers 404. In one example, there may be two (or more) network interfaces, such as Ethernet and Infiniband™. When there are two simultaneous connections on different interfaces (or the same interface), the device firmware guarantees that, even if operations are overlapped for processing commands from both connections, the operations are performed as if they are strictly serial in nature (i.e. with regard to the semantics of sequential execution of atomic operations).

The device 402-1 may include a read cache 414 for get transactions and a write cache 416 for put transactions. The controller 418 includes at least one processor, local memory and executable code for controlling operations of key/value storage device 402-1. The storage medium 420 may be a non-volatile data storage medium, such as hard disk storage or solid-state disk storage. It is contemplated that a volatile data storage medium, such as RAM (random access memory) disk storage, may be used in some applications.

In a second exemplary implementation, the key/value storage device 402-2 may be implemented by connecting a front-end processor 432 to a conventional storage device 436. The front-end processor 432 includes one or more network interfaces 412 and a controller 418 for controlling operations of key/value storage device 402-2. The front-end processor 432 also includes the network interface(s) 412 to the communications network(s) 401 and a storage device interface 434 to the conventional storage device 436. The front-end processor 432 may also include a read cache 414 for get transactions and a write cache 416 for put transactions. The conventional storage device 436 may be, for example, a hard disk drive or a solid-state disk drive. For instance, the conventional storage device 436 may be a Serial Attached SCSI (SAS) drive or a Serial ATA (SATA) drive.

As described above, the key/value storage device 402 may include read and write caches (414 and 416). The sizes of these caches may be specific to the device.

Note that, unlike the read cache 414, the write cache 416 is to be guaranteed to be non-volatile across power failure events. An exemplary embodiment allows the entries in the write cache to be read/written in arbitrary order in the event that elevator algorithms and/or SMR bands might cause the device to perform separate flushes of Key/Values at different times, rather than some strict round-robin ordering.

Further, note that the key/value storage device 402 may provide estimates of the amount of time that it will take to empty N slots in the write cache queue in order to be able to accept additional write operations. This feature may be particularly useful if the device supports a storage protocol that does not have an implicit penalty in long delays before being able to accept additional write requests. For example, in some systems, such write requests may be handled by other devices until this storage device is able to accept an additional write request.

H) Simplified Example of Computer Apparatus for a Server

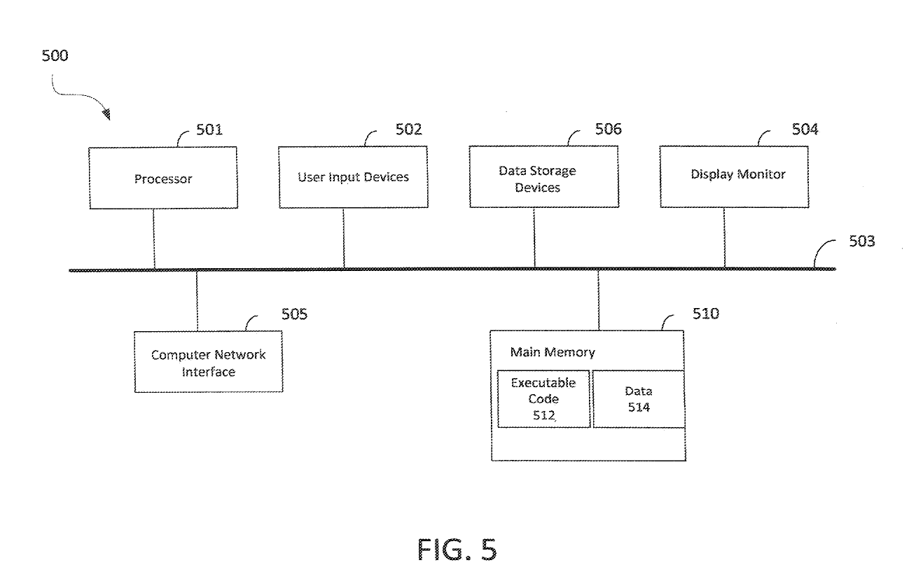

FIG. 5 depicts a simplified example of a computer apparatus 500 which may be configured as a server in the system in accordance with an embodiment of the invention. This figure shows just one simplified example of such a computer. Many other types of computers may also be employed, such as multi-processor computers.

As shown, the computer apparatus 500 may include a processor 501, such as those from the Intel Corporation of Santa Clara, California, for example. The computer apparatus 500 may have one or more buses 503 communicatively interconnecting its various components. The computer apparatus 500 may include one or more user input devices 502 (e.g., keyboard, mouse, etc.), a display monitor 504 (e.g., liquid crystal display, flat panel monitor, etc.), a computer network interface 805 (e.g., network adapter, modem), and a data storage system that may include one or more data storage devices 506 which may store data on a hard drive, semiconductor-based memory, optical disk, or other tangible non-transitory computer-readable storage media 507, and a main memory 510 which may be implemented using random access memory, for example.

In the example shown in this figure, the main memory 510 includes instruction code 512 and data 514. The instruction code 512 may comprise computer-readable program code (i.e., software) components which may be loaded from the tangible non-transitory computer-readable medium 507 of the data storage device 506 to the main memory 510 for execution by the processor 501. In particular, the instruction code 512 may be programmed to cause the computer apparatus 500 to operate as a server that interacts with one or more key/value storage devices as disclosed herein.

H) Select Inventive Aspects

One inventive aspect of the present disclosure provides a key/value storage device supports a simple command set and architecture which includes serialization of metadata updates to chunks and/or manifest data. These metadata updates are the elemental data that need to be serialized to allow multiple servers to safely access any file system place on a drive with multiple host access. In an exemplary file system, the two basic pieces of metadata that require serialization of updates for safe access by multiple servers are back references and attribute data, although for other file systems placed on the device, additional metadata may require serialization for safe operations.

Another inventive aspect provides safe access to a storage device without requiring explicit lock mechanisms or introducing a “state full” operation to the device. In an exemplary file system, the serialization of the back references and the attribute data for a key/value store are the two essential ingredients which enable this safe access. In an exemplary implementation, these (and other operations) can be made “atomic” operations through a combination of the Compare and Exchange of keys and the stateless serial updates by using signed blocks.

Another inventive aspect provides stateless serial updates across multiple blocks. In addition to using the technique using Compare and Exchange to serialize the update of a single block of data, the problem remains for how to update the entire tree or linked list of blocks that are pointed to by the serialized update. Conventionally, a linked list of prior version numbers would only contain the data about the version numbers that occurred in the past. Under this inventive aspect, in order to allow two trees to simultaneously exist without some members of the list mapping to the same cryptographic hash (or, in this instance, the key for the block), each of the blocks is copied to the new version and is modified by signing the block with data unique to this particular update. Although the cryptographic hash of the new version BLOB would be an acceptable signature, signing the block with the sourceID of the originating server and the timestamp of the update that caused the block to be copied, will make the copy unique. It has the added advantage that in the event of a power failure interrupting the serialized update before completion, the new copies will be easily identified as orphan BLOBs since there will be no pointer in the key list on the device that points to the chain of BLOBs.

Another inventive aspect relates to a storage device that provides a predictive response time for a transaction (such as, for example, a get, put or delete transaction). In an exemplary implementation, the key/value storage device provides a prediction for when it will be able to accept a transaction, based on the depth and state of the transaction log so that transactions may be routed to other devices if the predicted time is too long. The predictive response time may be provided in an error response that includes the predicted time at which a request may be processed, or it may be provided in response to a driver interrogatory command that asks for the predicted time to read/write a BLOB. Such an interrogatory command may be processed asynchronously by the device in order to allow the server to make predictive responses to get/put proposals from higher layers.

Another inventive aspect relates to a storage device that provides a predictive response time for a get (read) request. The device generates a predicted response time for how long it will take the device to respond to a get (read) request based on whether the information is cached or how long it will require to retrieve from non-volatile storage. In addition, the number of queued get/put/delete operations queued ahead of this request affects the predicted time.

Another inventive aspect relates to a storage device that provides a predictive response time for a put (write) request. The device generates a predicted response time for how long it will take the device to respond to a put (write) request based on whether there is cache space available and/or whether the non-volatile storage is fragmented or contiguous which can affect put times. In addition, the number of queued get, put and delete operations queued ahead of this request affects the predicted time.

Another inventive aspect relates to a storage device that provides a predictive response time for a delete request. The key/value storage device generates a prediction for when it will be able to perform a delete (Del) transaction based on the depth and state of the transaction queue. A Del operation may take longer for fragmented BLOBs than for contiguous BLOBs, depending on the device's internal organization.

Another inventive aspect relates to a storage device that provides a predictive busy time when it is currently reorganizing data from one location to another within the storage medium. While the device is in the middle of reorganizing data from one location to another, the device may keep all of its internal reading/writing queues busy during that time and may respond with a predictive busy (how long before it can accept new read/write requests). When the device is performing a relocation of content that has previously been stored on the device, it may temporarily store the data to be rewritten in Read cache, rather than the Transaction Logging Write Cache, since all such data may already be preserved in non-volatile storage.

Another inventive aspect relates to stateless serial updates across multiple blocks. In addition to using the technique of Compare and Exchange to serialize the update of a single block of data, the problem remains for how to update the entire tree or linked list of blocks that are pointed to by the serialized update. However, a linked list of prior version numbers would only contain the data about the version numbers that occurred in the past. In accordance with an embodiment of the invention, in order to allow two trees to simultaneously exist without some members of the list mapping to the same cryptographic hash (or in this instance the key for the block), each of the blocks is copied to the new version and is modified by “signing” (encoding) the block with data unique to this particular update. Although the cryptographic hash of the new version BLOB would be an acceptable signature, signing the block with the sourceID of the originating server and the timestamp of the update that caused the block to be copied makes the copy unique. It has the added advantage that, in the event of a power failure interrupting the serialized update before completion, the new copies will be easily identified as orphan BLOBs since there will be no pointer in the key list on the device that points to the chain of BLOBs.

Another inventive aspect relates to a write cache organized using a transaction log. The key/value storage device supports write operations in a non-volatile transaction log and refuses to accept storage requests when there are no available slots in the transaction log.

Another inventive aspect relates to write cache operations directed by source. The key/value storage device supports write operations in the transaction log under the direction of the commands that are issued. The content of the log entries are embedded in the command. The log entries are performed in the same atomic step as the received command without performing any other commands. This behavior may be performed in an overlapping sequence as long as the atomicity of the commands and the transaction log semantics are preserved.

Another inventive aspect relates to write cache operations implicit in commands. The key/value storage device supports write operations in the transaction log as an implicit side effect of specific commands that are issued to the device. Commands such as Compare and Exchange are examples of such commands that will track the date and time of the command as well as the source of the command and the old and new values.

Another inventive aspect relate to a cache implemented with volatile memory. The volatile-memory cache may be a separate memory that is used not just for the BLOB buffers awaiting transfer to non-volatile storage, but also as a cache for the transaction logging of commands that have taken place. The types of transaction log entries that the device may record in such a cache include the source ID of the issuer of the commands, the type of command, and some optional contents of the command.

Another inventive aspect relates to a cache backed by a non-volatile store even during unexpected power loss. The cache is preserved to a non-volatile storage in the event of an unexpected power loss. The cache size will always be maintained in such a fashion that there will always be free space available in the cache or that processing of further commands/operation will be suspended until there is free space. During the restoration of power, the short term non-volatile storage will be flushed to the long-term non-volatile storage in a named Key/Value pairing that is specific to the device.

Another inventive aspect relates to a cache that is periodically preserved automatically to non-volatile storage. In addition to the backing in non-volatile store during an unexpected power loss, the contents of the cache are periodically preserved on the long-term non-volatile storage of the device in a Key/Value pairing that is specific to the device and that can be retrieved at a later time.

Another inventive aspect relates to a key/value storage device that computes the cryptographic hash of the BLOB and then continues computing the cryptographic hash of the User-Supplied Key appended to the end of the BLOB. In this way, the key/value storage device is able to verify that both the BLOB and the User-Supplied Key have been received intact without corruption. Doing so is at a very small incremental cost above the cost of verifying the BLOB alone.

Below is a listing of some embodiments of the presently-disclosed invention. Other embodiments are disclosed herein.

### Embodiment 1

A key/value storage device comprising:

a storage medium for storing data;

at least one network interface for receiving a plurality of commands sent by a plurality of servers; and

a controller that accepts the plurality commands but performs operations for each command of the plurality of commands on an atomic basis without interfering operations from other commands of the plurality of commands,

wherein the plurality of commands includes a put command from a first server to store a binary data object on the storage medium, wherein the put command passes a key associated with the binary data object to the key/value storage device, and the key/value storage device returns a cryptographic hash of the binary data object to the first server via the at least one network interface.

### Embodiment 2

The key/value storage device of Embodiment 1, wherein the key/value storage device comprises hard disk storage.

### Embodiment 3

The key/value storage device of Embodiment 1, wherein the key/value storage device comprises solid-state disk storage.

### Embodiment 4

The key/value storage device of Embodiment 1, wherein the key/value storage device comprises random access memory disk storage.

### Embodiment 5

The key/value storage device of Embodiment 1, wherein the controller and the at least one network interface are part of a front-end processor that is attached to a disk drive which includes the storage medium.

### Embodiment 6

The key/value storage device of Embodiment 1, wherein the key comprises a cryptographic hash of the binary data object.

### Embodiment 7

The key/value storage device of Embodiment 1, wherein the key comprises a user-defined key.

### Embodiment 8

The key/value storage device of Embodiment 1, wherein the key is passed by the put command within a key data structure, and wherein fields in the key data structure are encoded.

### Embodiment 9

The key/value storage device of Embodiment 8, wherein the fields in the key data structure comprises a binary data object type, a length of the binary data object, and the key.

### Embodiment 10

The key/value storage device of Embodiment 9, wherein the fields in the key data structure further comprises a unique digest of the binary data object with the key.

### Embodiment 11

The key/value storage device of Embodiment 1, wherein the key is stored on the key/value storage device in a list of keys that is accessible to the controller.

### Embodiment 12

The key/value storage device of Embodiment 1, wherein the plurality of commands further includes a get command from a second server to retrieve the binary data object from the storage medium, wherein the get command passes the key associated with the binary data object to the key/value storage device, and the key/value storage device returns the binary data object to the second server via the network interface.

### Embodiment 13

A method of storing binary data objects in a key/value storage device having a network interface, the method comprising:

receiving a put command to store a binary data object in the key/value storage device, wherein the put command is received from a server via the network interface and passes a key associated with the binary data object;

storing the binary data object within the key/value storage device;

storing the key passed by the put command; and

returning a cryptographic hash of the binary data object to the server via the network interface.

### Embodiment 14

The method of Embodiment 13, wherein the key comprises a cryptographic hash of the binary data object.

### Embodiment 15

The method of Embodiment 13, wherein the key comprises a user-defined key.

### Embodiment 16

The method of Embodiment 13, wherein the key is passed by the put command within a key data structure, and wherein fields in the key data structure are encoded.

### Embodiment 17

The method of Embodiment 16, wherein the fields in the key data structure comprises a binary data object type, a length of the binary data object, and the key.

### Embodiment 18

The method of Embodiment 17, wherein the fields in the key data structure further comprises a unique digest of the binary data object with the key.

### Embodiment 19

A method of accessing binary data objects in a key/value storage device having a network interface, the method comprising:

receiving a get command to obtain a binary data object from the key/value storage device, wherein the get command is received from a server via the network interface;

locating the binary data object within the key/value storage device using a key provided with the get command; and

returning the binary data object to the server via the network interface.

### Embodiment 20

The method of Embodiment 19, wherein the key/value storage device comprises hard disk storage.

### Embodiment 21

The method of Embodiment 19, wherein the key/value storage device comprises solid-state disk storage.

### Embodiment 22

The method of Embodiment 19, wherein the key/value storage device comprises random access memory disk storage.

### Embodiment 23

The method of Embodiment 19, wherein the key comprises a cryptographic hash of the binary data object.

### Embodiment 24

The method of Embodiment 19, wherein the key comprises a user-defined key.

### Embodiment 25

A system for storing and accessing data, the system comprising:

a plurality of servers;

a plurality of key/value storage devices communicatively connected to the plurality of servers by way of a data network, each key/value storage device comprising
a storage medium for storing data,
a network interface for receiving commands sent by the plurality of servers, and
a controller that processes a put command from a server to store a binary data object on the storage medium, wherein the put command passes a key associated with the binary data object, and returns a cryptographic hash of the binary data object to the server via the network interface.

### Embodiment 26

A storage drive comprising:

a storage medium for storing data;

a network interface for receiving multiple commands sent by multiple servers; and

a controller that processes multiple commands from the multiple servers to access binary data objects on the storage medium,

wherein the multiple commands include updates to back references in a chunk storage system, and

wherein the updates to back references are serialized by the controller.

### Embodiment 27

The storage drive of Embodiment 26, wherein the controller performs the updates to the back references on an atomic basis by using compare and exchange of keys and by stateless serial updates using signed blocks

### Embodiment 28

The storage drive of Embodiment 26, wherein the multiple commands further include updates to attribute data in the chunk storage system, and wherein the updates to attribute data are serialized by the storage drive.

### Embodiment 29

The storage drive of Embodiment 28, wherein the controller performs the updates to the attribute data on an atomic basis by using compare and exchange of keys and by stateless serial updates using signed blocks.

### Embodiment 30

A storage drive comprising:

a storage medium for storing data;

a network interface for receiving multiple commands sent by multiple servers; and

a controller that processes multiple commands from the multiple servers to access binary data objects on the storage medium,

wherein the multiple commands include data updates that are processed on an atomic basis by using compare and exchange of keys and by stateless serial updates using signed blocks.

### Embodiment 31

The storage drive of Embodiment 30, wherein the data updates include updates to back references and attribute data in a chunk storage system.

### Embodiment 32

A storage drive comprising:

a storage medium for storing data;

a network interface for receiving multiple commands sent by multiple servers; and

a controller that processes multiple commands from the multiple servers to access binary data objects on the storage medium,

wherein the controller performs an update of a block of data that points to a linked list of blocks by creating a new version of the block of data and all the blocks in the linked list.

### Embodiment 33

The storage drive of Embodiment 32, wherein the version of the block of data and all the blocks in the linked list are signed with data unique to the update.

### Embodiment 34

The storage drive of Embodiment 33, wherein the data unique to the update comprises a source identifier of an originating server that sent the update and a timestamp of the update.

### Embodiment 35

A storage drive comprising:

a storage medium for storing data;

a network interface for receiving multiple commands sent by multiple servers; and

a controller that processes multiple requests from the multiple servers to access binary data objects on the storage medium, wherein the controller provides a predictive response time for a request that indicates a predicted time at which the request is to be processed.

### Embodiment 36

The storage drive of Embodiment 35, wherein the multiple requests comprise get requests, put requests, and delete requests.

### Embodiment 37

The storage drive of Embodiment 35, wherein the predictive response time is based on a depth and state of a transaction queue.

### Embodiment 38

The storage drive of Embodiment 35, wherein the predictive response time is provided in response to a driver interrogatory command for the predicted time to process the request.

### Embodiment 39

A storage drive comprising:

a storage medium for storing data;

a network interface for receiving multiple commands sent by multiple servers; and

a controller that provides a predictive busy time when the controller is currently reorganizing data from one location to another within the storage medium, wherein the predictive busy time indicates how long before the storage drive can accept new read or write requests.

### Embodiment 40

The storage drive of Embodiment 39, wherein the storage drive temporarily stores data to be rewritten in a read cache when the storage drive is performing relocation of content that has previously been stored in the storage drive.

### Embodiment 41

A storage drive comprising:

a non-volatile storage medium for storing data;

a network interface for receiving multiple commands sent by multiple servers;

a write cache for holding data to be written to the non-volatile storage medium;

a non-volatile transaction log for the write cache; and

a controller that performs write operations from the non-volatile transaction log and refuses to accept further write requests when there are no available slots in the non-volatile transaction log.

### Embodiment 42

The storage drive of Embodiment 41, wherein the write operations from the non-volatile transaction log are performed on an atomic basis.

### Embodiment 43

The storage drive of Embodiment 41, wherein contents of entries in the non-volatile transaction log are embedded in commands received by the storage drive from the multiple servers.

### Embodiment 44

The storage drive of Embodiment 41, wherein write cache operations are performed by the controller as implicit side effects of a command issued to the storage drive.

### Embodiment 45

The storage drive of Embodiment 44, wherein the command comprises a compare and exchange, and the write cache operations track a date and time of the command, a source of the command, and old and new values due to the compare and exchange.

### Embodiment 46

The storage drive of Embodiment 41, wherein the write cache is implemented in volatile memory.

### Embodiment 47

The storage drive of Embodiment 46, further comprising a transaction log cache that is implemented in volatile memory.

### Embodiment 48

The storage drive of Embodiment 46, further comprising:

non-volatile storage that backs up the write cache implemented in volatile memory such that contents of the write cache are preserved in event of an unexpected power loss.

### Embodiment 49

The storage drive of Embodiment 48, wherein the non-volatile storage is flushed to the non-volatile storage medium in a named key/value pairing upon restoration of power.

### Embodiment 50

The storage drive of Embodiment 41, wherein the write cache is periodically preserved to non-volatile storage.

I) Glossary of Select Terms

Cryptohash: A “cryptographic hash” or “cryptohash” refers to a function which returns the cryptographic hash of a BLOB. The exact selection of which cryptographic hash function is chosen will be an implementation dependent choice based on the number of objects that are intended to be held or managed by the storage system. Introduced in 1992, the MD5 cryptographic hash was thought to be secure enough to avoid collisions, but a series of sophisticated analyses proved that it could be compromised by generating two different source texts that yielded the same MD5 cryptopgraphic hash. For this reason, preferred implementations should use SHA256, SHA512, SHA1024 or later cryptographic hash algorithms. In addition, preferred implementations should audit on a periodic basis that when a subsystem (e.g. a device) claims that it is already holding a value with a key that is presented to the subsystem, that the held value is indeed the same as the value which the parent system is attempting to store.

Chunk: A “chunk” refers to a sequence of payload bytes that hold a portion of the payload for one or more objects in an object storage system. An object may have one or more constituent chunks, and a chunk may belong to one or more objects.

Chunk Backreference: A “chunk backreference” is a reference (pointer) from the chunk back to an object that includes the chunk. A single chunk may have multiple chunk backreferences that point to different objects.

Version Manifest: A “version manifest” refers to an encoding of the metadata for a specific version of an object held by the manifest subsystem.

Nexenta CCOW™: The Nexenta Cloud Copy-on-Write (CCOW™) object storage system may refer to one or more object storage systems developed by, or to be developed by, Nexenta Systems of Santa Clara, California.

Atomic Operation: A formal definition of an atomic operation is an operation performed in a way that excludes all other operations which may alter its inputs or update its outputs. A command is performed on an atomic basis if a set of steps for the command (such as, compare and exchange) is performed in a single uninterrupted step without overlapping/interfering operations performed under the direction of another command. If the device could simultaneously perform compare-and-exchange operations from two servers without atomicity of the command performances (i.e., the performances are overlapping or interfering), then the results of the compare-and-exchange operations would be compromised. Similarly, a log/journal entry for a put/get/del operation may be performed in an atomic manner in that it is to be completed before operations of potentially interfering commands are started.

1-25. (canceled)

26. A storage drive comprising:
a storage medium for storing data;
a network interface for receiving multiple commands sent by multiple servers; and
a controller that processes multiple commands from the multiple servers to access binary data objects on the storage medium,
wherein the multiple commands include updates to back references in a chunk storage system, and
wherein the updates to back references are serialized by the controller.

27. The storage drive of claim 26, wherein the controller performs the updates to the back references on an atomic basis by using compare and exchange of keys and by stateless serial updates using signed blocks.

28. The storage drive of claim 26, wherein the multiple commands further include updates to attribute data in the chunk storage system, and wherein the updates to attribute data are serialized by the storage drive.

29. The storage drive of claim 28, wherein the controller performs the updates to the attribute data on an atomic basis by using compare and exchange of keys and by stateless serial updates using signed blocks.

30. A storage drive comprising:
a storage medium for storing data;
a network interface for receiving multiple commands sent by multiple servers; and
a controller that processes multiple commands from the multiple servers to access binary data objects on the storage medium,
wherein the multiple commands include data updates that are processed on an atomic basis by using compare and exchange of keys and by stateless serial updates using signed blocks.

31. The storage drive of claim 30, wherein the data updates include updates to back references and attribute data in a chunk storage system.

32. A storage drive comprising:
a storage medium for storing data;
a network interface for receiving multiple commands sent by multiple servers; and
a controller that processes multiple commands from the multiple servers to access binary data objects on the storage medium,
wherein the controller performs an update of a block of data that points to a linked list of blocks by creating a new version of the block of data and all the blocks in the linked list.

33. The storage drive of claim 32, wherein the version of the block of data and all the blocks in the linked list are signed with data unique to the update.

34. The storage drive of claim 33, wherein the data unique to the update comprises a source identifier of an originating server that sent the update and a timestamp of the update.

35. A storage drive comprising:
a storage medium for storing data;
a network interface for receiving multiple commands sent by multiple servers; and
a controller that processes multiple requests from the multiple servers to access binary data objects on the storage medium, wherein the controller provides a predictive response time for a request that indicates a predicted time at which the request is to be processed.

36. The storage drive of claim 35, wherein the multiple requests comprise get requests, put requests, and delete requests.

37. The storage drive of claim 35, wherein the predictive response time is based on a depth and state of a transaction queue.

38. The storage drive of claim 35, wherein the predictive response time is provided in response to a driver interrogatory command for the predicted time to process the request.

39. A storage drive comprising:
a storage medium for storing data;
a network interface for receiving multiple commands sent by multiple servers; and
a controller that provides a predictive busy time when the controller is currently reorganizing data from one location to another within the storage medium, wherein the predictive busy time indicates how long before the storage drive can accept new read or write requests.

40. The storage drive of claim 39, wherein the storage drive temporarily stores data to be rewritten in a read cache when the storage drive is performing relocation of content that has previously been stored in the storage drive.

41. A storage drive comprising:
a non-volatile storage medium for storing data;
a network interface for receiving multiple commands sent by multiple servers;
a write cache for holding data to be written to the non-volatile storage medium;
a non-volatile transaction log for the write cache; and
a controller that performs write operations from the non-volatile transaction log and refuses to accept further write requests when there are no available slots in the non-volatile transaction log.

42. The storage drive of claim 41, wherein the write operations from the non-volatile transaction log are performed on an atomic basis.

43. The storage drive of claim 41, wherein contents of entries in the non-volatile transaction log are embedded in commands received by the storage drive from the multiple servers.

44. The storage drive of claim 41, wherein write cache operations are performed by the controller as implicit side effects of a command issued to the storage drive.

45. The storage drive of claim 44, wherein the command comprises a compare and exchange, and the write cache operations track a date and time of the command, a source of the command, and old and new values due to the compare and exchange.

46. The storage drive of claim 41, wherein the write cache is implemented in volatile memory.

47. The storage drive of claim 46, further comprising a transaction log cache that is implemented in volatile memory.

48. The storage drive of claim 46, further comprising:
non-volatile storage that backs up the write cache implemented in volatile memory such that contents of the write cache are preserved in event of an unexpected power loss.

49. The storage drive of claim 48, wherein the non-volatile storage is flushed to the non-volatile storage medium in a named key/value pairing upon restoration of power.

50. The storage drive of claim 41, wherein the write cache is periodically preserved to non-volatile storage.
